(19) United States
(12) Patent Application Publication
(10) Pub. No.: US 2023/0400733 A1
(43) Pub. Date: Dec. 14, 2023

(54) DISPLAY DEVICE, LIGHT GUIDE, AND DISPLAY DEVICE MANUFACTURING METHOD

(71) Applicant: Japan Display Inc., Tokyo (JP)

(72) Inventor: Tenfu NAKAMURA, Tokyo (JP)

(21) Appl. No.: 18/330,393

(22) Filed: Jun. 7, 2023

(30) Foreign Application Priority Data
Jun. 9, 2022 (JP) 2022-093912

(51) Int. Cl. G02F 1/13357; G02F 1/1334; F21V 8/00

(52) U.S. Cl. CPC G02F 1/133615; G02F 1/1334; G02B 6/005

(57) ABSTRACT

According to one embodiment, a display device includes a display panel where an image is displayed, a transparent substrate having a main surface opposed to the display panel, and a first side surface connected to the main surface, a light source emitting light toward the first side surface, a low-refractive layer formed on the main surface and having a refractive index smaller than a refractive index of the transparent substrate, a protective layer covering the low-refractive layer and an adhesive layer bonding the display panel to the protective layer.

### CROSS-REFERENCE TO RELATED APPLICATIONS

This application is based upon and claims the benefit of priority from Japanese Patent Application No. 2022-093912, filed Jun. 9, 2022, the entire contents of which are incorporated herein by reference.

### FIELD

Embodiments described herein relate generally to a display device, a light guide, and a display device manufacturing method.

### BACKGROUND

In recent years, a display device comprising a display panel including a polymer dispersed liquid crystal layer (PDLC) has been proposed. The polymer dispersed liquid crystal layer can switch a scattering state in which light is scattered and a transparent state in which light is transmitted. The display device can display images by switching the display panel to the scattering state. In contrast, the user can visually recognize a background through the display panel by switching the display panel to the transparent state.

### BRIEF DESCRIPTION OF THE DRAWINGS

FIG. 1 is a plan view showing a configuration example of a display device according to one of embodiments.

FIG. 2 is a cross-sectional view showing a configuration example of the display panel shown in FIG. 1.

FIG. 3 is an exploded perspective view showing main portions of the display device shown in FIG. 1.

FIG. 4 is a plan view showing a configuration example of a light guide shown in FIG. 3.

FIG. 5 is a plan view showing another configuration example of the light guide.

FIG. 6 is a cross-sectional view schematically showing a configuration example of the display device.

FIG. 7 is a partially enlarged view showing a light guide and an adhesive layer shown in FIG. 6.

FIG. 8 is a view illustrating a method of manufacturing the display device.

FIG. 9 is a view illustrating a method of manufacturing the display device.

FIG. 10 is a view illustrating a method of manufacturing the display device.

FIG. 11 is a view illustrating a method of manufacturing the display device.

### DETAILED DESCRIPTION

In general, according to one embodiment, a display device comprises a display panel where an image is displayed, a transparent substrate having a main surface opposed to the display panel, and a first side surface connected to the main surface, a light source emitting light toward the first side surface, a low-refractive layer formed on the main surface and having a refractive index smaller than a refractive index of the transparent substrate, a protective layer covering the low-refractive layer, and an adhesive layer bonding the display panel to the protective layer.

According to another embodiment, a light guide is overlapping with a display panel where an image is displayed. The light guide comprises a transparent substrate having a main surface opposed to the display panel, and a first side surface which is connected to the main surface and to which light is emitted, a low-refractive layer formed on the main surface and having a refractive index smaller than a refractive index of the transparent substrate, and a protective layer covering the low-refractive layer.

According to yet another embodiment, a display device manufacturing method comprises forming a low-refractive layer having a refractive index smaller than a refractive index of the transparent substrate, on a main surface of a transparent substrate having the main surface, forming a protective layer covering the low-refractive layer, bonding the protective layer to a display panel on which an image is displayed, and washing the transparent substrate on which the low-refractive layer and the protective layer are formed, with a solvent, before bonding the protective layer to the display panel.

According to the above-described configurations, a display device, a light guide, and a display device manufacturing method capable of suppressing the degradation in display quality can be provided.

One of embodiments will be described hereinafter with reference to the accompanying drawings. The disclosure is merely an example, and proper changes in keeping with the spirit of the invention, which are easily conceivable by a person of ordinary skill in the art, come within the scope of the invention as a matter of course. In addition, in some cases, in order to make the description clearer, the widths, thicknesses, shapes and the like, of the respective parts are schematically illustrated in the drawings, compared to the actual modes. However, the schematic illustration is merely an example, and adds no restriction to the interpretation of the invention.

In the drawings, reference numbers of continuously arranged elements equivalent or similar to each other are omitted in some cases. In addition, in the specification and drawings, structural elements which function in the same or a similar manner to those described in connection with preceding drawings are denoted by like reference numbers, detailed description thereof being omitted unless necessary.

In the present embodiment, a first direction X, a second direction Y, and a third direction Z are defined as shown in each figure. The first direction X, the second direction Y, and the third direction Z are orthogonal to each other, but may intersect each other at an angle other than 90 degrees. In addition, in the present embodiment, the third direction Z is defined as an upper or upward direction, and a direction opposite to the third direction Z is defined as a lower or downward direction.

Expressions such as “a second component above a first component” and “a second component beneath a first component” mean that the second component may be in contact with the first component or may be located apart from the first component. Viewing an X-Y plane defined by the first direction X and the second direction Y is hereinafter referred to as planar view.

In the present embodiment, a liquid crystal display device which enables a background to be visually recognized, to which polymer dispersed liquid crystal is applied, is disclosed as an example of the display device. The present embodiment does not prevent application of individual technical ideas disclosed in the present embodiment to the other types of display devices.

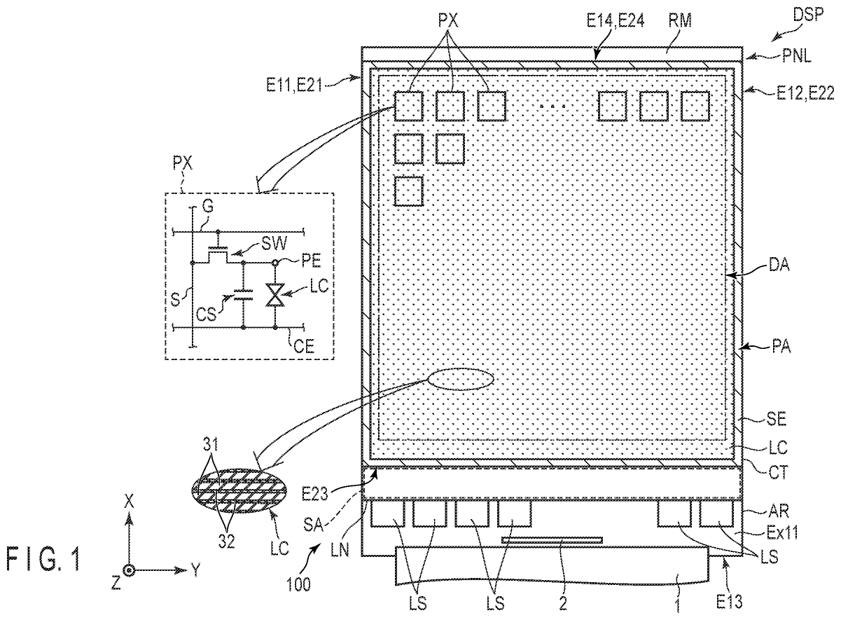

FIG. 1 is a plan view showing a configuration example of a display device DSP according to the present embodiment. As shown in FIG. 1, the display device DSP comprises a display panel PNL including a polymer dispersed liquid crystal layer (hereinafter simply referred to as a liquid crystal layer LC), a wiring board 1, an IC chip 2, a light source unit 100, and a reflective material RM. The display device DSP further comprises a light guide 30 and a cover member which will be described below.

The display panel PNL includes an array substrate AR, a counter-substrate CT opposed to the array substrate AR, a liquid crystal layer LC, and a seal SE. The array substrate AR and the counter-substrate CT are formed in flat plate shapes parallel to the X-Y plane. The array substrate AR and the counter-substrate CT overlap in planar view. The array substrate AR and the counter-substrate CT are bonded by the seal SE. The liquid crystal layer LC is arranged between the array substrate AR and the counter-substrate CT and is sealed by the seal SE. In FIG. 1, the liquid crystal layer LC is represented by dots and the seal SE is represented by hatch lines.

As enlarged and schematically shown in FIG. 1, the liquid crystal layer LC contains polymer 31 and liquid crystal molecules 32. As an example, the polymer 31 is liquid crystalline polymer. The polymer 31 is formed in a stripe shape extending along the second direction Y and is aligned in the first direction X.

The liquid crystal molecules 32 are dispersed in gaps of the polymer 31 and aligned such that their long axes extend along the first direction X. The polymer 31 and the liquid crystal molecules 32 have optical anisotropy or refractive anisotropy. The response performance of the polymer 31 to the electric field is lower than the response performance of the liquid crystal molecules 32 to the electric field.

As an example, the orientation of alignment of the polymer 31 is hardly varied irrespective of the presence or absence of the electric field. In contrast, the orientation of alignment of the liquid crystal molecules 32 is varied in accordance with the electric field in a state in which a voltage higher than or equal to the threshold value is applied to the liquid crystal layer LC.

For example, in a state in which the voltage is not applied to the liquid crystal layer LC, optical axes of the polymer 31 and the liquid crystal molecules 32 are parallel to one another and the light made incident on the liquid crystal layer LC is not substantially scattered in the liquid crystal layer LC and transmitted (transparent state).

In a state in which the voltage is applied to the liquid crystal layer LC, the optical axes of the polymer 31 and the liquid crystal molecules 32 intersect one another and the light made incident on the liquid crystal layer LC is scattered in the liquid crystal layer LC (scattered state). In other words, the liquid crystal layer LC can switch the transparent state and the scattered state in accordance with the applied voltage.

The display panel PNL includes a display area DA on which images are displayed and a surrounding area PA which surrounds the display area DA. The seal SE is located in the surrounding area PA. The display area DA includes pixels PX arrayed in a matrix in the first direction X and the second direction Y.

As shown and enlarged in FIG. 1, each pixel PX comprises a switching element SW, a pixel electrode PE, a common electrode CE, a liquid crystal layer LC, and the like. The switching element SW is formed of, for example, a thin-film transistor (TFT) and is electrically connected to a scanning line G and a signal line S. The scanning line G is electrically connected to the switching element SW in each of the pixels PX arranged in the second direction Y. The signal line S is electrically connected to the switching element SW in each of the pixels PX arranged in the first direction X.

The pixel electrode PE is electrically connected to the switching element SW. The common electrode CE is provided commonly to a plurality of pixel electrodes PE. The liquid crystal layer LC (particularly, liquid crystal molecules 32) is driven by an electric field produced between the pixel electrode PE and the common electrode CE. A capacitance CS is formed, for example, between the common electrode CE and an electrode having the same potential and between the pixel electrode PE and an electrode having the same potential.

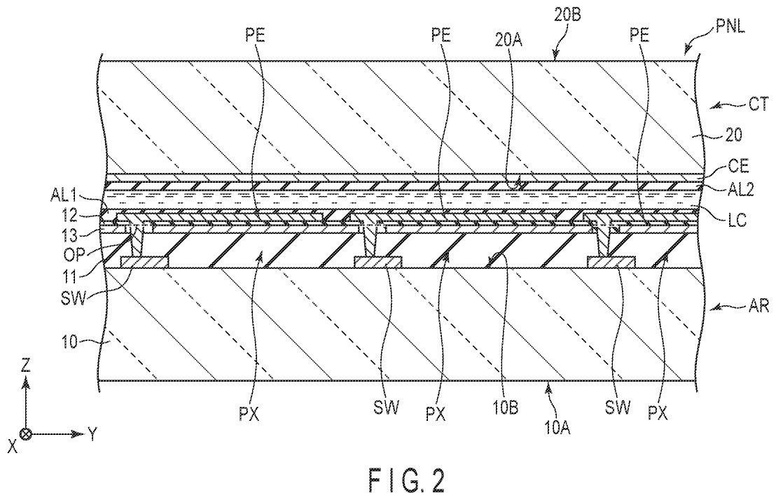

The scanning line G, the signal line S, the switching element SW, and the pixel electrode PE are provided on the array substrate AR, and the common electrode CE is provided on the counter-substrate CT, which will be described below with reference to FIG. 2. On the array substrate AR, the scanning line G and the signal line S are electrically connected to the wiring board 1 or the IC chip 2.

The array substrate AR has a pair of side surfaces E11 and E12 extending in the first direction X and a pair of side surfaces E13 and E14 extending in the second direction Y. In the example shown in FIG. 1, the pair of side surfaces E11 and E12 are side surfaces formed along the long sides of the display panel PNL, and the pair of side surfaces E13 and E14 are side surfaces formed along the short sides of the display panel PNL.

The counter-substrate CT has a pair of side surfaces E21 and E22 extending in the first direction X and a pair of side surfaces E23 and E24 extending in the second direction Y. In the example shown in FIG. 1, the pair of side surfaces E21 and E22 are side surfaces formed along the long sides, and the pair of side surfaces E23 and E24 are side surfaces formed along the short sides.

In the example shown in FIG. 1, the side surface E11 overlaps with the side surface E21 in planar view, but may not overlap with the side surface E21. In the example shown in FIG. 1, the side surface E12 overlaps with the side surface E22 in planar view, but may not overlap with the side surface E22. In the example shown in FIG. 1, the side surface E14 overlaps with the side surface E24 in planar view, but may not overlap with the side surface E24.

The array substrate AR includes an extending portion Ex11 which extends beyond the side surface E23 of the counter-substrate CT. From the other viewpoint, the extending portion Ex11 does not overlap with the counter-substrate CT. The extending portion Ex11 is located between the side surface E13 and the side surface E23. The wiring board 1 and the IC chip 2 are mounted on the extending portion Ex11.

The wiring board 1 is, for example, a flexible printed circuit which can be bent. The IC chip 2 incorporates, for example, a display driver which outputs a signal necessary for image display, and the like. The IC chip 2 may be mounted on the wiring board 1.

In the example shown in FIG. 1, the display device DSP comprises a single wiring board 1, but may comprise a plurality of wiring boards. The display device DSP comprises a single IC chips 2, but may comprise a plurality of IC chips.

In the example shown in FIG. 1, the light source unit 100 overlaps with the extending portion Ex11 in planar view. The light source unit 100 includes a plurality of light sources LS, a lens LN, and a support member SA. The plurality of light sources LS are spaced apart and arranged in the second direction Y.

In the light sources LS, red LEDs, green LEDs, and blue LEDs are continuously aligned. The light sources LS are not limited to an arrangement in which LEDs of three different colors are continuously aligned but, for example, only white light sources emitting white light may be continuously aligned.

The lens LN (for example, prism lens) is formed in the form of a transparent rod and extends in the second direction Y. The lens LN is formed of, for example, resin. The lens LN has, for example, a plurality of curved surfaces corresponding to the plurality of light sources LS, and controls the length along the second direction Y of light emitted from the light sources LS. The lens LN may be composed of a plurality of lenses. The number of light sources LS and the number of lenses LN are not limited to the examples shown in the figure.

The reflective material RM is provided on the side opposite to the light source unit 100 in the first direction X. The reflective material RM is provided along the second direction Y. The reflective material RM is formed of, for example, a metallic material having light-reflecting properties, such as silver. The reflective material RM is, for example, a reflective tape.

FIG. 2 is a cross-sectional view showing a configuration example of the display panel PNL shown in FIG. 1. The array substrate AR includes a transparent substrate 10, insulating films 11 and 12, a capacitive electrode 13, switching elements SW, the pixel electrodes PE, and an alignment film AL1. The transparent substrate 10 has a main surface 10A and a main surface 10B on a side opposite to the main surface 10A.

The switching elements SW are provided on the main surface 10B side. The insulating film 11 is provided on the main surface 10B to cover the switching elements SW. The scanning lines G and the signal lines S described with reference to FIG. 1 are provided between the transparent substrate 10 and the insulating film 11, but their illustration is omitted here. The capacitive electrode 13 is provided between the insulating films 11 and 12.

The pixel electrodes PE are provided between the insulating film 12 and the alignment film AL1, in the respective pixels PX. From the other viewpoint, the capacitive electrode 13 is provided between the transparent substrate 10 and the pixel electrodes PE. The pixel electrodes PE are electrically connected to the switching elements SW through apertures OP of the capacitive electrode 13. The pixel electrodes PE overlap with the capacitive electrode 13 through the insulating film 12 to form the capacitances CS of the pixels PX. The alignment film AL1 covers the pixel electrodes PE.

The counter-substrate CT includes a transparent substrate 20, a common electrode CE, and an alignment film AL2. The transparent substrate 20 includes a main surface 20A and a main surface 20B on a side opposite to the main surface 20A. The main surface 20A of the transparent substrate 20 is opposed to the main surface 10B of the transparent substrate 10.

The common electrode CE is provided on the main surface 20A. The alignment film AL2 covers the common electrode CE. The liquid crystal layer LC is located between the main surface 10B and the main surface 20A and is in contact with the alignment films AL1 and AL2.

In the counter-substrate CT, a light-shielding layer may be provided just above each of the switching elements SW, the scanning lines G, and the signal lines S. A transparent insulating film may be provided between the transparent substrate 20 and the common electrode CE or between the common electrode CE and the alignment film AL2.

The common electrode CE is arranged over the plurality of pixels PX and is opposed to the plurality of pixel electrodes PE in the third direction Z. The common electrode CE has the same potential as the capacitive electrode 13. The liquid crystal layer LC is located between the pixel electrodes PE and the common electrode CE.

The transparent substrates 10 and 20 are, for example, glass substrates but may be insulating substrates such as plastic substrates. The main surfaces 10A and 10B, and the main surfaces 20A and 20B are the surfaces substantially parallel to the X-Y plane. The insulating film 11 includes, for example, a transparent inorganic insulating film of silicon oxide, silicon nitride, silicon oxynitride or the like, and a transparent organic insulating film of acrylic resin or the like.

The insulating film 12 is, for example, a transparent inorganic insulating film of silicon nitride or the like. The capacitive electrode 13, the pixel electrodes PE, and the common electrode CE are, for example, transparent electrodes formed of a transparent conductive material such as indium tin oxide (ITO) or indium zinc oxide (IZO).

The alignment films AL1 and AL2 are horizontal alignment films having an alignment restriction force substantially parallel to the X-Y plane. As an example, the alignment films AL1 and AL2 are subjected to alignment treatment in the second direction Y. The alignment treatment may be a rubbing treatment or an optical alignment treatment.

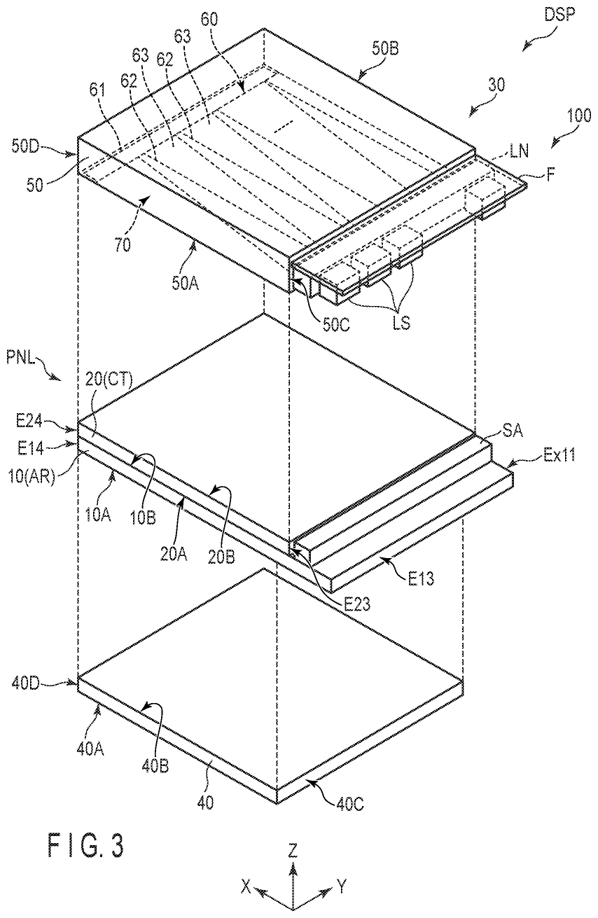

FIG. 3 is an exploded perspective view showing main portions of the display device DSP shown in FIG. 1. In FIG. 3, the reflective material RM and the like are partially omitted.

As described with reference to FIG. 1, the display device DSP comprises the display panel PNL and the light source unit 100. The display device DSP further comprises a light guide 30 which overlaps with the display panel PNL, and a cover member 40. The cover member 40, the array substrate AR, the counter-substrate CT, and the light guide 30 are aligned in this order along the third direction Z.

The light guide 30 includes a transparent substrate 50, a low-refractive layer 60, and a protective layer 70. The transparent substrate 50 is formed in a flat plate shape. The transparent substrate 50 is, for example, a glass substrate, but may be an insulating substrate such as a plastic substrate.

The transparent substrate 50 has a main surface 50A, a main surface 50B on a side opposite to the main surface 50A, and a pair of side surfaces 50C and 50D that connect the main surface 50A with the main surface 50B. The side surface 50C corresponds to the first side surface, and the side surface 50D corresponds to the second side surface. A direction from the side surface 50C to the side surface 50D corresponds to the first direction X.

The main surfaces 50A and 50B are surfaces substantially parallel to the X-Y plane. The main surface 50A is opposed to the main surface 20B of the transparent substrate 20. The pair of side surfaces 50C and 50D are surfaces substantially parallel to an Y-Z plane defined by the second direction Y and the third direction Z. In the first direction X, the side surface 50D is a side surface opposite to the side surface 50C.

The low-refractive layer 60 is formed on the main surface 50A. A refractive index of the low-refractive layer 60 is smaller than a refractive index of the transparent substrate 50. The low-refractive layer 60 is a transparent layer and is formed of, for example, an organic material such as siloxane-based resin. The low-refractive layer 60 includes a base 61, a plurality of band portions 62, and a plurality of apertures 63 formed between the plurality of band portions 62. The low-refractive layer 60 is in contact with the main surface 50A at the plurality of band portions 62.

The protective layer 70 covers the low-refractive layer 60 from the display panel PNL side. A part of the protective layer 70 is located at the plurality of apertures 63 and is in contact with the main surface 50A. A refractive index of the protective layer 70 is greater than that of the low-refractive layer 60. The protective layer 70 is formed of a material having a high transmittance.

In this example, “high transmittance” means, for example, that the transmittance of light in the wavelength range from 400 nm to 800 nm is 98% or higher. The protective layer 70 is formed of, for example, an organic material such as siloxane-based resin. As another example, the protective layer 70 may be formed of an inorganic material such as SiO₂ or SiON.

The cover member 40 is formed in a flat plate shape. The cover member 40 is an insulating substrate such as a glass substrate or a plastic substrate. The cover member 40 has a main surface 40A, a main surface on a side opposite to the main surface 40A, and a pair of side surfaces 40C and 40D that connect the main surface 40A with the main surface 40B.

The main surfaces 40A and 40B are the surfaces substantially parallel to the X-Y plane. The main surface 40B is opposed to the main surface 10A of the transparent substrate 10. The pair of side surfaces 40C and 40D are the surfaces substantially parallel to the Y-Z plane. The light guide 30 and the cover member 40 do not overlap with the extending portion Ex11 in the third direction Z.

As described with reference to FIG. 1, the light source unit 100 includes the light sources LS, the lens LN, and the support member SA. The light source unit 100 further includes a wiring board F. The plurality of light sources LS are mounted on the wiring board F. The wiring board F is, for example, a printed circuit board and is more rigid than the wiring board 1 shown in FIG. 1.

The plurality of light sources LS and the lens LN are opposed to the side surface 50C in the first direction X. The plurality of light sources LS emit light toward the side surface 50C. The lens LN is located between the transparent substrate 50 and the light sources LS in the first direction X. The support member SA is located between the extending portion Ex11 and the lens LN in the third direction Z.

The support member SA is a rod-shaped member extending in the second direction Y. The support member SA is formed of acrylic resin or glass, as an example, but is not limited to this example. The support member SA is desirably formed of an opaque material that is not transparent. The support member SA may be a single member or may be composed of a plurality of members.

Next, the shape of the low-refractive layer will be described.

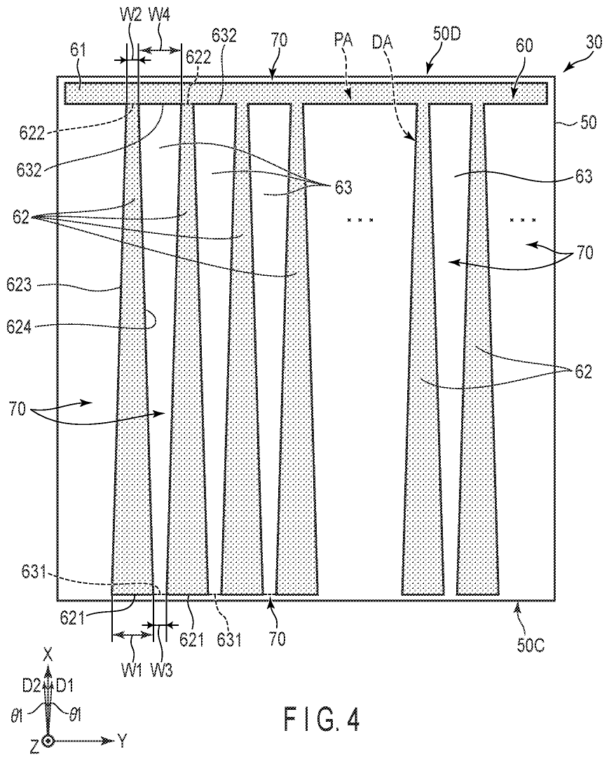

FIG. 4 is a plan view showing a configuration example of the light guide 30 shown in FIG. 3. As described with reference to FIG. 3, the low-refractive layer 60 includes the base 61, the plurality of band portions 62, and the plurality of apertures 63 formed between the plurality of band portions 62. For example, the base 61 and the plurality of band portions 62 are formed integrally.

The base 61 is located on the side surface side on the main surface 50A. The base 61 has a substantially rectangular shape extending in the second direction Y. In planar view, the base 61 has a pair of short sides along the first direction X and a pair of long sides along the second direction Y.

The plurality of band portions 62 extend in the first direction X and are spaced apart in the second direction Y. The band portion 62 includes a first end portion 621 on the side surface 50C side, a second end portion 622 on a side opposite to the first end portion 621, a first edge 623, and a second edge 624. The second end portions 622 correspond to portions of the plurality of band portions 62, on the side surface 50D side. The plurality of band portions 62 are connected to the long side on the side surface side, of the base 61, at the second end portions 622.

A length of the first end portion 621 along the second direction Y is referred to as a first width W1, and a length of the second end portion 622 along the second direction Y is referred to as a second width W2. In the example shown in FIG. 4, the first width W1 is greater than the second width W2 (W1>W2).

The first edge 623 and the second edge 624 extend in a direction different from the first direction X and the second direction Y, at positions between the first end portion 621 and the second end portion 622. For example, a direction intersecting the first direction X clockwise at an acute angle is defined as a direction D1, and a direction intersecting the first direction X counterclockwise at an acute angle is defined as a direction D2.

The angle θ1 formed between the first direction X and the direction D1 and the angle θ1 formed between the first direction X and the direction D2 are, for example, the same as each other, but are not limited to this example, and the angle formed between the first direction X and the direction D1 may be different from the angle formed between the first direction X and the direction D2.

The first edge 623 extends along the direction D1, and the second edge 624 extends along the direction D2. In the example shown in FIG. 4, both the first edge 623 and the second edge 624 extend linearly, but may be formed in a curved shape. Thus, the band portion 62 has a width which decreases at a constant rate or an arbitrary rate from the first end portion 621 to the second end portion 622 along the first direction X.

The aperture 63 is located between two adjacent band portions 62. The aperture 63 includes a third end portion 631 between the first end 621 of one band portion 62 and the first end portion 621 of the other band portion 62, and a fourth end portion 632 between the second end portion 622 of one band portion 62 and the second end portion 622 of the other band portion 62. The fourth end portion 632 is, for example, a portion which is in contact with the long side of the base 61 on the side surface 50C side.

A length of the third end portion 631 along the second direction Y is referred to as a third width W3, and a length of the fourth end portion 632 along the second direction Y is referred to as a fourth width W4. The third width W3 corresponds to an interval between the first end portion 621 of one band portion 62 and the first end portion 621 of the other band portion 62. The fourth width W4 corresponds to an interval between the second end portion 622 of one band portion 62 and the second end portion 622 of the other band portion 62.

The third width W3 is smaller than the fourth width W4 (W3<W4). The aperture 63 has a width which increases at a constant rate or an arbitrary rate from the third end portion 631 to the fourth end portion 632 along the first direction X.

In the example shown in FIG. 4, the low-refractive layer 60 is, for example, located inside the outer shape of the transparent substrate 50. Therefore, the protective layer 70 surrounds the outer periphery of the low-refractive layer 60. From the other viewpoint, a part of the protective layer 70 is located between the base 61 and the side surface 50D, and a part of the protective layer 70 is located between the plurality of band portions 62 and the side surface 50C, in the first direction X. Furthermore, the protective layer 70 sandwiches the plurality of band portions 62, in the second direction. The low-refractive layer 60 may be formed in a size equivalent to the outer shape of the transparent substrate 50.

When the display panel PNL and the light guide 30 overlap, the plurality of band portions 62 overlap with the display area DA, and the base 61 overlaps with the peripheral area PA, in planar view. In the display area DA, the first edges 623 and the second edges 624 which are inclined to the first direction X and the second direction Y, of the plurality of band portions 62, overlap with the display area DA.

In the transparent substrate 50, the side surface 50C side corresponds to the area close to the light sources LS, and the side surface 50D side corresponds to the area separated from the light sources LS. By constituting the low-refractive layer as described above, the area of contact between the main surface 50A and the plurality of band portions 62 is larger in the area closer to the light sources LS and smaller in the area farther from the light sources LS.

The area where the main surface 50A and the plurality of band portions 62 overlap corresponds to an area where light made incident on the transparent substrate 50 is hardly made incident on the display panel PNL side. The area where the main surface 50A and the plurality of apertures 63 overlap corresponds to an area where light made incident on the transparent substrate 50 can be made incident on the display panel PNL side.

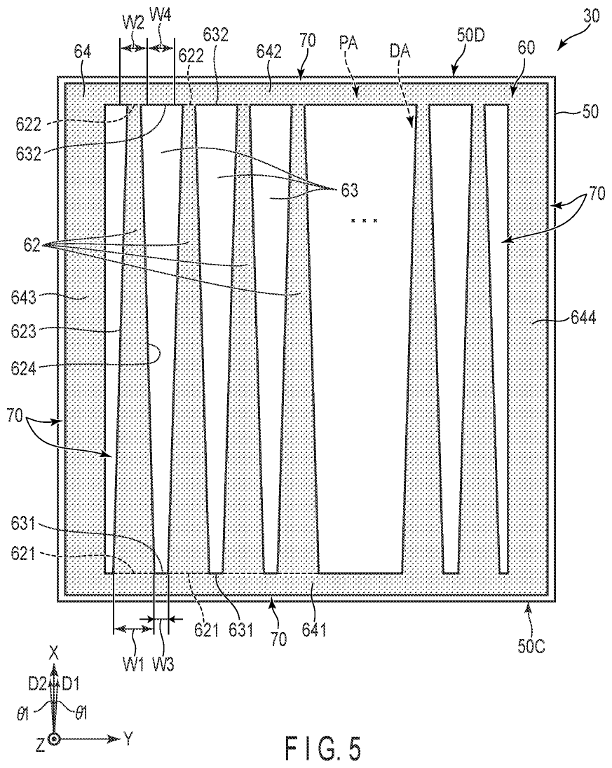

FIG. 5 is a plan view showing another configuration example of the light guide 30. In the example shown in FIG. 5, the low-refractive layer 60 includes a plurality of band portions 62, a frame portion 64 surrounding the plurality of band portions 62, and the apertures 63. The plurality of band portions 62 and the frame portion 64 are, for example, formed integrally.

The apertures 63 are formed between the plurality of band portions 62, and between the band portions 62 and the frame portion 64. The low-refractive layer 60 is different from the low-refractive layer 60 described with reference to FIG. 4 in including the frame portion 64 instead of the base 61.

For example, the outer shape of the frame portion 64 is located inside the outer shape of the transparent substrate 50. Therefore, the protective layer 70 surrounds the outer periphery of the low-refractive layer 60. The frame portion 64 overlaps with the peripheral area PA, and the inner side of the frame portion 64 corresponds to the display area DA. The frame portion 64 includes a first portion 641 and a second portion 642 which extend along the second direction Y, and a third portion 643 and a fourth portion 644 which extend along the first direction X.

The first portion 641 is located between the side surface 50C and the display area DA, and the second portion 642 is located between the side surface and the display area DA, in the first direction X. The first end portions 621 of the plurality of band portions 62 are connected to the first portion 641, and the second end portions 622 of the plurality of band portions 62 are connected to the second portion 642.

The shape of the low-refractive layer 60 is not limited to the examples shown in FIG. 4 and FIG. 5, but may be other shapes. For example, the amount of light made incident on the display panel PNL side, and the like can be adjusted by changing the shape of the band portions 62 or changing the size of the band portions 62.

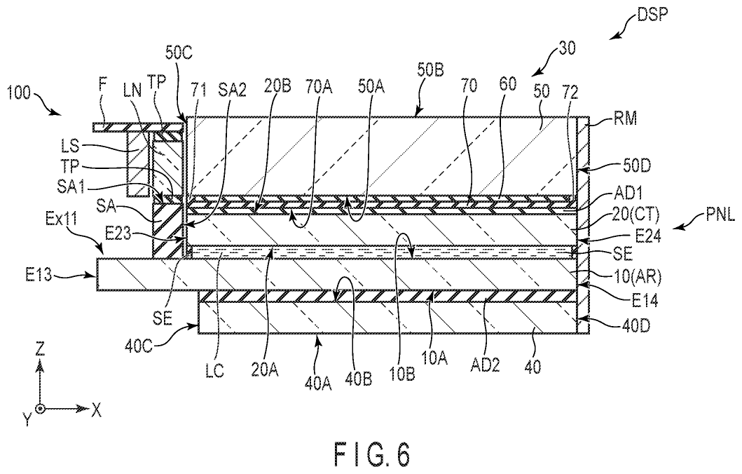

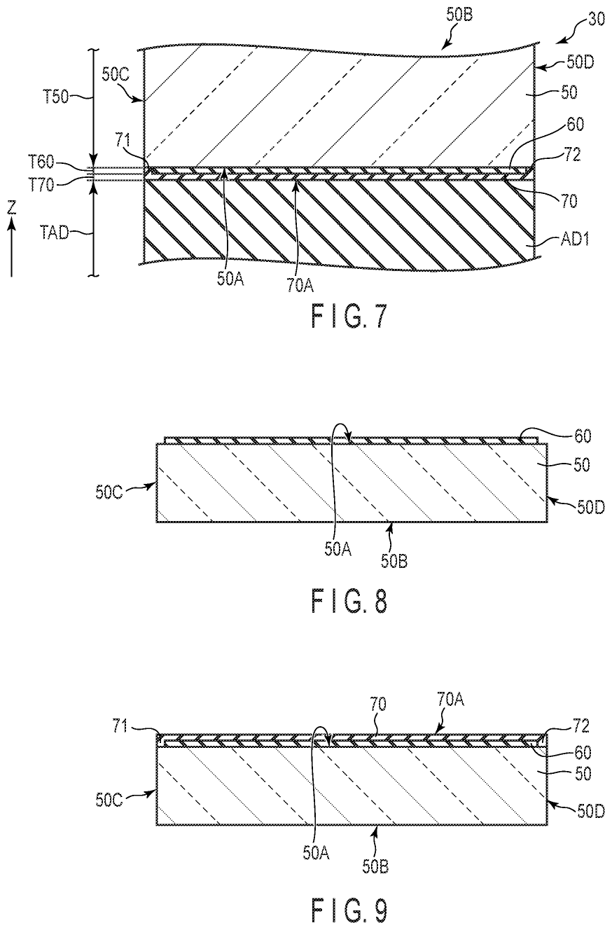

FIG. 6 is a cross-sectional view schematically showing a configuration example of the display device DSP. FIG. 7 is a partially enlarged view showing the light guide 30 and the adhesive layer AD1 shown in FIG. 6. In FIG. 6, the wiring board 1, the IC chip 2, and the like are omitted. The only main parts of the display panel PNL are simply illustrated. In the example shown in FIG. 6, the low-refractive layer 60 has the shape described with reference to FIG. 4.

As described with reference to FIG. 3, the light guide 30 includes the transparent substrate 50, the low-refractive layer 60, and the protective layer 70. The transparent substrate 50 is, for example, a single substrate. The low-refractive layer 60 is in contact with the main surface 50A of the transparent substrate 50.

The protective layer 70 covers the low-refractive layer 60 and the main surface 50A of the transparent substrate 50. A part of the protective layer 70 is located at the plurality of apertures 63 of the low-refractive layer 60 and is also in contact with the main surface 50A. The protective layer 70 has a main surface 70A opposed to the transparent substrate 20.

As described with reference to FIG. 4, when the low-refractive layer 60 is formed inside the outer shape of the transparent substrate 50, the protective layer 70 has a portion located outside the low-refractive layer 60. More specifically, the protective layer 70 includes an edge 71 located closely to the side surface 50C side than to the low-refractive layer and an edge 72 located closely to the side surface side than to the low-refractive layer 60.

Each of the edges 71 and 72 is in contact with the main surface 50A of the transparent substrate 50. The edge 71 is in contact with the first end portion 621 of the band portion 62, and the edge 72 is in contact with the base 61. The first end portion 621 and the base 61 are not exposed by forming the edges 71 and 72, and the low-refractive layer 60 is hardly peeled off from the main surface 50A of the transparent substrate 50. When the outer shape of the low-refractive layer 6 is formed to be the same size as the outer shape of the transparent substrate 50, the edges 71 and 72 are not formed.

The side surface 50C is located directly above the side surface E23 in the third direction Z, and the side surface 50D is located directly above the side surface E24. The side surface 40C is not located directly below the side surface 50C in the third direction Z, but may be located directly below the side surface 50C. The side surface 40D is located directly below the side surface 50D in the third direction Z.

The side surface 40D, the side surface E14, the side surface E24, and the side surface 50D are aligned along the third direction Z, but may be displaced. The reflective material RM is provided along the third direction Z, from the side surface 40D to the side surface 50D.

The display device DSP further comprises an adhesive layer AD1 and an adhesive layer AD2. The adhesive layer AD1 is located between the display panel PNL and the light guide 30, and the adhesive layer AD2 is located between the display panel PNL and the cover member 40, in the third direction Z. The adhesive layer AD1, the protective layer 70, the low-refractive layer 60, and the transparent substrate 50 are aligned in this order along the third direction Z.

The adhesive layer AD1 bonds the display panel PNL to the protective layer 70. From the other viewpoint, the adhesive layer AD1 is in contact with the main surface 20B of the transparent substrate 20 and the main surface 70A of the protective layer 70. The adhesive layer AD2 bonds the display panel PNL to the cover member 40. From the other viewpoint, the adhesive layer AD2 is in contact with the main surface of the transparent substrate 10 and the main surface 40B of the cover member 40.

The adhesive layers AD1 and AD2 are formed of, for example, optical clear adhesive (OCA). The adhesive layers AD1 and AD2 may be formed of optical clear resin (OCR). The refractive indices of the adhesive layers AD1 and AD2 are greater than the refractive index of the low-refractive layer 60.

In the example shown in FIG. 6, the thickness of each of the transparent substrate 10, the transparent substrate 20, and the cover member 40 is approximately equal. In this example, thickness refers to the length along the third direction Z. The thickness of the transparent substrate 50 is greater than, for example, the thickness of each of the transparent substrate 10, the transparent substrate 20, and the cover member 40. The thickness of the transparent substrate 50 is greater than, for example, the thickness of the lens LN.

As shown in FIG. 7, a thickness T70 of the protective layer 70 is less than a thickness T50 of the transparent substrate 50 and a thickness TAD of the adhesive layer AD1. The thickness T70 of the protective layer 70 is desirably small from the viewpoint of light absorption and the like.

For example, the thickness T60 of the low-refractive layer 60 is 1 μm (0.001 mm) and the thickness T70 of the protective layer 70 is 1 to 2 μm (0.001 mm to 0.002 m). For example, the thickness T50 of the transparent substrate 50 is 700 μm to 1,500 μm (0.7 mm to 1.5 mm), and 2,750 μm (2.75 mm) at maximum. For example, the thickness TAD of the adhesive layer AD1 is 125 μm (0.125 mm).

The refractive index of each of the transparent substrates 10 and 20, the protective layer 70, the adhesive layers AD1 and AD2, and the cover member 40 is equivalent to the refractive index of the transparent substrate 50 and greater than that of the low-refractive layer 60. In this example, “equivalent” is not limited to a case where the difference in refractive index is zero, but indicates a case where the difference in refractive index is 0.03 or less.

The difference between the refractive index of the transparent substrate 50 and the refractive index of the low-refractive layer 60 is, for example, approximately 0.1. As an example, the refractive index of the transparent substrate 50 is 1.5, the refractive index of the low-refractive layer 60 is 1.41, the refractive index of the protective layer 70 is 1.5, and the refractive index of the adhesive layers AD1 and AD2 is 1.474.

The light source unit 100 overlaps with the extending portion Ex11. The light source LS and lens LN are provided between the extending portion Ex11 and the wiring board F in the third direction Z.

In the example shown in FIG. 6, the cross-section of the support member SA is a rectangular shape. The support member SA has an upper surface SA1 and a side surface SA2. The upper surface SA1 is opposed to the lens LN. The side surface SA2 is opposed to the side surface E23 of the transparent substrate 20. A reflective material capable of reflecting light may be provided on the upper surface SA1. Light from the lens LN is less likely to reach the side surface E23 through the support member SA, by providing the reflective material on the upper surface SA1.

For convenience of description, in the example shown in FIG. 1, the size of the support member SA is smaller than the size of the lens LN in planar view, but the size of the support member SA is, desirably, approximately equal to the size of the lens LN in planar view.

In the example shown in FIG. 6, the upper surface SA1 of the support member SA is located above the main surface 20B of the transparent substrate 20 in the third direction Z. The upper surface SA1 of the support member SA may be located on the same plane as the main surface 20B of the transparent substrate 20.

The lens LN is bonded to the wiring board F by the adhesive material TP and to the support member SA by the adhesive material TP. The support member SA is bonded to the main surface 10B by an adhesive material (not shown). These adhesive materials TP are, for example, double-sided tapes.

The light source LS, the lens LN, and the transparent substrate 50 are aligned in this order along the first direction X. The lens LN is located above the support member SA, and the light source LS and the lens LN are not opposed to the side surface E23. Therefore, light emitted from the light source LS is hardly made incident from the side surface E23.

The light source LS is further separated from the display panel PNL than the low-refractive layer 60. From the other viewpoint, the light source LS is located above the low-refractive layer 60, in the third direction Z. The low-refractive layer 60 is located between the light source LS and the display panel PNL, in the third direction Z.

Next, the light emitted from the light source LS will be described.

The light emitted from the light source LS is moderately diffused on the lens LN and is made incident on the transparent substrate 50 from the side surface 50C.

The light made incident on the transparent substrate 50 from the side surface 50C reaches the liquid crystal layer LC through the transparent substrate 50. As described above, the refractive index of the low-refractive layer 60 is lower than that of the transparent substrate 50. For this reason, light traveling from the transparent substrate 50 toward the low-refractive layer 60, of the light made incident on the transparent substrate 50, is reflected on an interface between the transparent substrate 50 and the low-refractive layer 60.

The light traveling toward the main surface of the light made incident on the transparent substrate 50, is reflected on an interface between the transparent substrate 50 and the air layer. The light travels inside the transparent substrate 50 while being repeatedly reflected, in the area where the transparent substrate 50 and the plurality of band portions 62 of the low-refractive layer 60 overlap.

Light traveling toward the area where the transparent substrate 50 and the plurality of apertures 63 of the low-refractive layer 60 overlap (i.e., the area where the transparent substrate 50 and the protective layer 70 are in contact with each other), of the light, is transmitted through the transparent substrate 50 and is made incident on the display panel PNL through the protective layer 70 and the adhesive layer AD1.

Since the refractive index of the protective layer 70 is equivalent to that of the transparent substrate 50, light is hardly reflected on the interface between the transparent substrate 50 and the adhesive layer AD1. Furthermore, since the refractive index of the protective layer 70 is equivalent to that of the adhesive layer AD1, light is hardly reflected on the interface between the protective layer 70 and the adhesive layer AD1.

The area of contact between the main surface and the plurality of band portions 62 is larger in the area closer to the light source LS and smaller in the area farther from the light source LS. For this reason, in the area close to the light source LS (side surface 50C side), the incidence of light from the light source LS on the display panel PNL is suppressed. In contrast, the incidence of light on the display panel PNL is promoted in the area separated from the light source LS (side surface 50D side).

In the area close to the light source LS, light is not made incident on the display panel PNL at all, but the light from the aperture 63 is made incident on the display panel PNL, as shown in FIG. 4 and FIG. 5. Since the side surface 50D is covered with the reflective material RM, light reaching the side surface 50D is scattered and reflected by the reflective material RM to travel inside the transparent substrate 50 in the direction opposite to the first direction X. Providing the reflective material RM prevents the light from leaking out of the side surface and reuses the light, thereby improving the light utilization efficiency.

The light made incident on the liquid crystal layer LC to which no voltage is applied is transmitted through the liquid crystal layer LC while hardly scattered. In contrast, the light made incident on the liquid crystal layer LC to which the voltage is applied is scattered by the liquid crystal layer LC. The display device DSP enables images to be observed from the main surface 50B side and also enables images to be observed from the main surface 40A side.

The display device DSP is so called a transparent display, and even when the display device DSP is observed from the main surface 50B side or observed from the main surface 40A side, a background of the display device DSP can be observed through the display device DSP.

Next, an example of a method of manufacturing the display device DSP will be described.

FIG. 8 to FIG. 11 are views illustrating the method of manufacturing the display device DSP. In FIG. 8 to FIG. 11, each step is shown in a cross-section parallel to the X-Z plane defined by the first direction X and the third direction Z. First, the display panel PNL comprising the above liquid crystal layer LC is manufactured. Further, the transparent substrate 50 having the above-described main surface 50A is manufactured.

Next, as shown in FIG. 8, the low-refractive layer 60 having a refractive index smaller than that of the transparent substrate 50 is formed on the main surface 50A of the transparent substrate 50. The low-refractive layer 60 is formed in a predetermined shape by, for example, a photolithographic process. In the case of the low-refractive layer 60 described with reference to FIG. 4 and FIG. 5, the low-refractive layer 60 includes a plurality of band portions 62 and a plurality of apertures 63.

Next, as shown in FIG. 9, the protective layer 70 covering the low-refractive layer 60 is formed. The material to form the protective layer 70 is applied to the entire low-refractive layer 60 (so-called overcoating). More specifically, the protective layer 70 covers the plurality of band portions 62, and is located at the apertures 63 and is in contact with the main surface 50A in the area where the plurality of apertures 63 overlap with the main surface 50A.

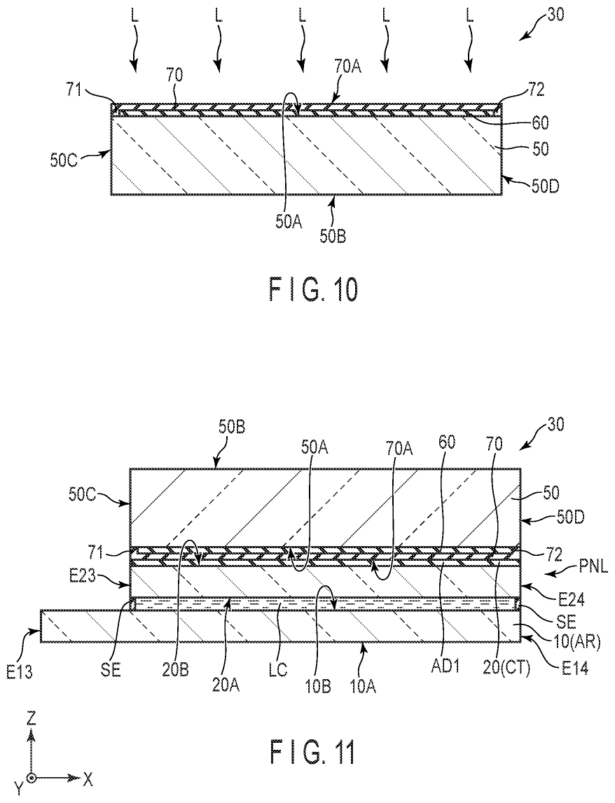

The protective layer 70 is formed such that, for example, the main surface 70A is a uniform surface (i.e., a surface approximately parallel to the X-Y plane). After each of these steps, the light guide 30 is manufactured. Then, as shown in FIG. 10, the transparent substrate 50 is washed with a solvent L before bonding the light guide 30 to the display panel PNL (after forming the protective layer 70).

The solvent L is, for example, acetone, ethanol, or the like. Since the low-refractive layer is covered with the protective layer 70, the protective layer 70 is in contact with the solvent L, but the low-refractive layer 60 is hardly in contact with the solvent L. Furthermore, as shown in FIG. 10, when the protective layer 70 includes the edges 71 and 72, the low-refractive layer 60 is also difficult to come into contact with the solvent L from the side surface 50C side and the side surface 50D side.

The material to form the protective layer 70 contains more cross-linking materials than the material to form the low-refractive layer 60. The cross-linking materials have a cross-linked structure formed by, for example, bonding (materials containing) silanol groups. As a result, the protective layer 70 has stronger bonds than the low-refractive layer 60 and is more resistant to the solvent L than the low-refractive layer 60. From the other viewpoint, the protective layer 70 is less soluble in solvents than the low-refractive layer 60.

Then, as shown in FIG. 11, the light guide 30 and the display panel PNL are bonded to each other. The transparent substrate 50 is bonded to the display panel PNL by the adhesive layer AD1 through the low-refractive layer 60 and the protective layer 70. The display device DSP comprising the light guide 30 including the protective layer 70 is manufactured through the manufacturing process including the above steps.

According to the display device DSP configured as described above, the display device DSP comprises the low-refractive layer 60 formed on the main surface 50A of the transparent substrate 50 and having a lower refractive index than the transparent substrate 50, the protective layer 70 covering the low-refractive layer 60, and the adhesive layer AD1 bonding the display panel PNL to the protective layer 70.

The low-refractive layer 60 is not exposed and is covered with the protective layer 70. For this reason, the low-refractive layer 60 does not come into contact with the solvent L in the manufacturing process of the display device DSP. Furthermore, the low-refractive layer 60 is covered with the protective layer 70, and its strength against physical shocks such as vibration is thereby improved.

In other words, the low-refractive layer 60 is not easily melted by washing with the solvent L or peeled off from the main surface 50A of the transparent substrate 50 by physical impact or the like. From the other viewpoint, the light guide 30 has a structure in which the low-refractive layer 60 is not easily damaged. As a result, the low-refractive layer 60 is formed stably against the transparent substrate 50.

The low-refractive layer 60 of the light guide 30 suppresses the incidence of light from the light source LS onto the display panel PNL in the area close to the light source LS, and promotes the incidence of light onto the display panel PNL in the area spaced apart from the light source LS.

The low-refractive layer 60 is formed stably with respect to the transparent substrate 50, and the light outcoupling efficiency of the light guide 30 can be thereby controlled appropriately. Thus, it is possible to suppress the decrease in luminance in the area separated from the light source LS and to reduce the difference in luminance between the area close to the light source LS and the area separated from the light source LS.

As a result, in the present embodiment, the degradation in display quality of the display device DSP can be suppressed by making the luminance uniform in the display panel PNL. Furthermore, since the low-refractive layer 60 can be stably formed on the light guide 30 with respect to the transparent substrate 50, the yield at manufacturing of the display device DSP is improved.

In the display device DSP of the present embodiment, the refractive index of each of the protective layer 70 and the adhesive layer AD1 is greater than the refractive index of the low-refractive layer 60 and is equivalent to that of the transparent substrate 50. The light traveling toward the area where the transparent substrate 50 overlaps with the plurality of apertures 63 can be transmitted through the transparent substrate 50, and then through the transparent substrate 20 via the protective layer 70 and the adhesive layer AD1.

In the display device DSP of the present embodiment, the thickness T70 of the protective layer is formed to be smaller than the thickness T50 of the transparent substrate 50 and the thickness TAD of the adhesive layer AD1. The absorption of light, which is transmitted through the protective layer 70, can be suppressed by making the thickness T70 of the protective layer 70 smaller. In the display device DSP of the present embodiment, the plurality of band portions 62 are connected to the long side of the base 61 on the side surface 50D side. Therefore, the plurality of band portions 62 are difficult to peel off from the side surface 50D side.

As described above, according to the present embodiment, the display device DSP capable of suppressing the degradation in display quality, the light guide 30, and the method for manufacturing the display device DSP can be provided.

All of the display devices that can be implemented by a person of ordinary skill in the art through arbitrary design changes to the display devices described above as embodiments of the present invention come within the scope of the present invention as long as they are in keeping with the spirit of the present invention. Various types of the modified examples are easily conceivable within the category of the ideas of the present invention by a person of ordinary skill in the art and the modified examples are also considered to fall within the scope of the present invention. For example, additions, deletions or changes in design of the constituent elements or additions, omissions, or changes in condition of the processes arbitrarily conducted by a person of ordinary skill in the art, in the above embodiments, fall within the scope of the present invention as long as they are in keeping with the spirit of the present invention.

In addition, the other advantages of the aspects described in the embodiments, which are obvious from the descriptions of the present specification or which can be arbitrarily conceived by a person of ordinary skill in the art, are considered to be achievable by the present invention as a matter of course.

What is claimed is:

1. A display device comprising:
a display panel where an image is displayed;
a transparent substrate having a main surface opposed to the display panel, and a first side surface connected to the main surface;
a light source emitting light toward the first side surface;
a low-refractive layer formed on the main surface and having a refractive index smaller than a refractive index of the transparent substrate;
a protective layer covering the low-refractive layer; and
an adhesive layer bonding the display panel to the protective layer.

2. The display device of claim 1, wherein
a refractive index of the protective layer is greater than the refractive index of the low-refractive layer.

3. The display device of claim 1, wherein
a refractive index of the adhesive layer is greater than the refractive index of the low-refractive layer.

4. The display device of claim 1, wherein
the transparent substrate is a glass substrate.

5. The display device of claim 1, wherein
a thickness of the protective layer is smaller than thicknesses of the transparent substrate and the adhesive layer.

6. The display device of claim 1, wherein
the transparent substrate further has a second side surface on a side opposite to the first side surface,
the low-refractive layer includes a plurality of band portions extending in a first direction from the first side surface toward the second side surface and arranged and spaced apart with intervals in a second direction orthogonal to the first direction, and a plurality of apertures formed between the plurality of band portions, and
the protective layer is in contact with the main surface at the apertures.

7. The display device of claim 6, wherein
the low-refractive layer further includes a base which extends in the second direction and to which portions on the second side surface side, of the plurality of band portions, are connected.

8. The display device of claim 6, wherein
a length in the second direction, of the band portions on the first side surface side, is greater than a length in the second direction, of the band portions on the second side surface side.

9. The display device of claim 1, wherein
the protective layer contains more cross-linking material than the low-refractive layer.

10. The display device of claim 1, wherein
the display panel includes a polymer dispersed liquid crystal layer, and
the polymer dispersed liquid crystal layer is able to switch a state of transmitting light made incident on the polymer dispersed liquid crystal layer and a state of scattering the light, in accordance with a voltage to be applied.

11. A light guide overlapping with a display panel where an image is displayed, the light guide comprising:
a transparent substrate having a main surface opposed to the display panel, and a first side surface which is connected to the main surface and to which light is emitted;
a low-refractive layer formed on the main surface and having a refractive index smaller than a refractive index of the transparent substrate; and
a protective layer covering the low-refractive layer.

12. The light guide of claim 11, wherein
a refractive index of the protective layer is greater than the refractive index of the low-refractive layer.

13. The light guide of claim 11, wherein
the transparent substrate is a glass substrate.

14. The light guide of claim 11, wherein
a thickness of the protective layer is smaller than a thickness of the transparent substrate.

15. The light guide of claim 11, wherein
the transparent substrate further has a second side surface on a side opposite to the first side surface,
the low-refractive layer includes a plurality of band portions extending in a first direction from the first side surface toward the second side surface and arranged and spaced apart with intervals in a second direction orthogonal to the first direction, and a plurality of apertures formed between the plurality of band portions, and
the protective layer is in contact with the main surface at the apertures.

16. The light guide of claim 15, wherein
the low-refractive layer further includes a base which extends in the second direction and to which portions on the second side surface side, of the plurality of band portions, are connected.

17. The light guide of claim 15, wherein
a length in the second direction, of the band portions on the first side surface side, is greater than a length in the second direction, of the band portions on the second side surface side.

18. The light guide of claim 11, wherein
the protective layer contains more cross-linking material than the low-refractive layer.

19. A display device manufacturing method comprising:
forming a low-refractive layer having a refractive index smaller than a refractive index of the transparent substrate, on a main surface of a transparent substrate having the main surface;
forming a protective layer covering the low-refractive layer;
bonding the protective layer to a display panel on which an image is displayed; and
washing the transparent substrate on which the low-refractive layer and the protective layer are formed, with a solvent, before bonding the protective layer to the display panel.

20. The method of claim 19, wherein
the protective layer is more resistant to the solvent than the low-refractive layer.
